(19) United States
(12) Patent Application Publication
(10) Pub. No.: US 2026/0221346 A1
(43) Pub. Date: Jul. 30, 2026

(54) MULTILAYER THIN FILM CAPACITOR AND METHOD FOR MANUFACTURING THE SAME

(71) Applicant: TDK Corporation, Tokyo (JP)

(72) Inventors: Hitoshi SAITA, Tokyo (JP); Mitsuhiro TOMIKAWA, Tokyo (JP); Rieki KAZAWA, Tokyo (JP)

(21) Appl. No.: 19/141,493

(22) PCT Filed: Dec. 14, 2023
(86) PCT No.: PCT/JP2023/044799

§ 371 Date: Jun. 20, 2025

(30) Foreign Application Priority Data
Dec. 26, 2022 (JP) 2022-208011

(51) Int. Cl. H01G 4/33

(52) U.S. Cl. CPC H01G 4/33

(57) ABSTRACT

To provide a multilayer thin film capacitor having high stiffness and being unlikely to undergo warpage. A multilayer thin film capacitor includes thin film capacitors, a resin layer positioned between the thin film capacitors and including a glass cloth, a terminal electrode connected to upper electrodes, and a terminal electrode connected to lower electrodes. Thus, there can be provided a multilayer thin film capacitor with high stiffness.

### TECHNICAL FIELD

The present disclosure relates to a multilayer thin film capacitor and a manufacturing method therefor.

### BACKGROUND ART

Patent Document 1 discloses a multilayer thin film capacitor including a plurality of laminated thin film capacitors.

### CITATION LIST

### Patent Document

[Patent Document 1] JP 2019-140312A

### DISCLOSURE OF THE INVENTION

### Problem to be Solved by the Invention

Multilayer thin film capacitors have reduced overall thickness and thus have problems of shortage in stiffness and easy occurrence of warpage.

The present disclosure describes a technology for enhancing the stiffness of a multilayer thin film capacitor and suppressing the occurrence of warpage thereof.

### Means for Solving the Problem

A multilayer thin film capacitor according to an aspect of the present disclosure in which a plurality of thin film capacitors including at least first and second thin film capacitors are laminated, the multilayer thin film capacitor comprising: a first thin film capacitor including a first lower electrode, a first upper electrode, and a first dielectric layer positioned between the first lower electrode and the first upper electrode; a second thin film capacitor including a second lower electrode, a second upper electrode, and a second dielectric layer positioned between the second lower electrode and the second upper electrode; a first resin layer positioned between the first thin film capacitor and the second thin film capacitor and including a glass cloth; a first terminal electrode formed on a first side surface of the first resin layer and connected to the first upper electrode and one of the second upper electrode and the second lower electrode; and a second terminal electrode formed on a second side surface of the first resin layer and connected to the first lower electrode and the other one of the second upper electrode and the second lower electrode.

A method for manufacturing a multilayer thin film capacitor according to an aspect of the present disclosure includes: a first step of forming first and second thin film capacitor sheets by performing a step of forming a dielectric layer and an upper electrode in this order on a lower electrode, a step of patterning the upper electrode to divide the upper electrode into a plurality of parts, and a step of patterning the lower electrode to divide the lower electrode into a plurality of parts; a second step of forming a multilayer thin film capacitor sheet by laminating the first and second thin film capacitor sheets through a first resin layer including a glass cloth; a third step of obtaining a plurality of individual multilayer thin film capacitors by dividing the multilayer thin film capacitor sheet; and a fourth step of forming, on a first side surface of the first resin layer, a first terminal electrode connected to the upper electrode included in the first thin film capacitor sheet and connected to one of the upper electrode and the lower electrode included in the second thin film capacitor sheet and forming, on a second side surface of the first resin layer, a second terminal electrode connected to the lower electrode included in the first thin film capacitor sheet and connected to the other one of the upper electrode and the lower electrode included in the second thin film capacitor sheet.

### Advantageous Effects of the Invention

According to the present disclosure, there can be provided a technology for enhancing the stiffness of a multilayer thin film capacitor and suppressing the occurrence of warpage thereof.

### BRIEF DESCRIPTION OF THE DRAWINGS

FIG. 1 is a schematic cross-sectional view for explaining the structure of a multilayer thin film capacitor 100 according to a first embodiment of the technology described herein.

FIG. 2 is a process view for explaining the manufacturing method for the multilayer thin film capacitor 100.

FIG. 3 is a process view for explaining the manufacturing method for the multilayer thin film capacitor 100.

FIG. 4 is a process view for explaining the manufacturing method for the multilayer thin film capacitor 100.

FIG. 5 is a process view for explaining the manufacturing method for the multilayer thin film capacitor 100.

FIG. 6 is a process view for explaining the manufacturing method for the multilayer thin film capacitor 100.

FIG. 7 is a process view for explaining the manufacturing method for the multilayer thin film capacitor 100.

FIG. 8 is a process view for explaining the manufacturing method for the multilayer thin film capacitor 100.

FIG. 9 is a process view for explaining the manufacturing method for the multilayer thin film capacitor 100.

FIG. 10 is a process view for explaining the manufacturing method for the multilayer thin film capacitor 100.

FIG. 11 is a schematic cross-sectional view for explaining the structure of a multilayer thin film capacitor 200 according to a second embodiment of the technology described herein.

### MODE FOR CARRYING OUT THE INVENTION

Hereinafter, preferred embodiments of the present invention will be described in detail with reference to the accompanying drawings.

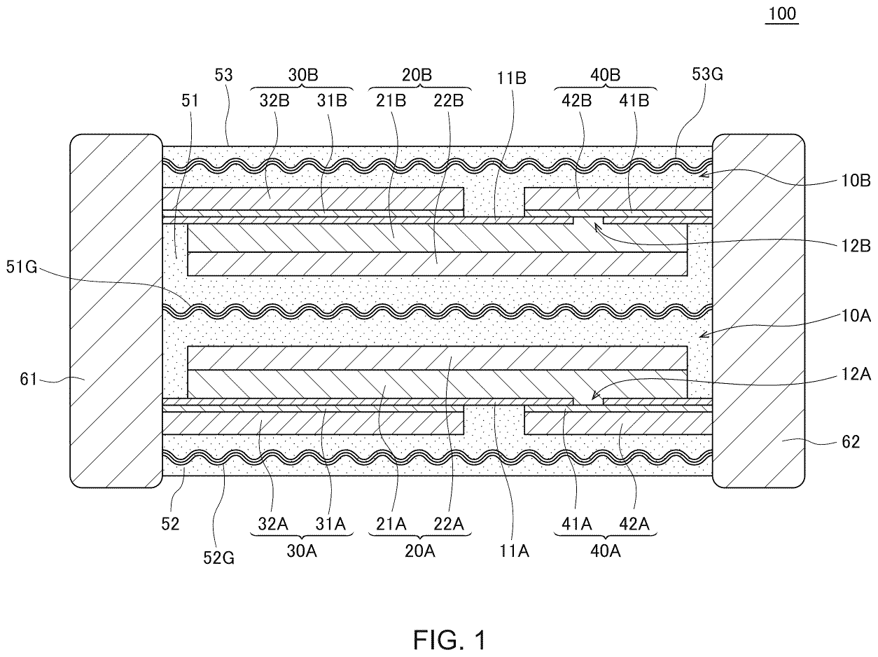

FIG. 1 is a schematic cross-sectional view for explaining the structure of a multilayer thin film capacitor 100 according to a first embodiment of the technology described herein.

As illustrated in FIG. 1, the multilayer thin film capacitor 100 according to the first embodiment has two laminated thin film capacitors 10A and 10B, resin layers 51 to 53 embedding therein the thin film capacitors 10A and 10B, and terminal electrodes 61 and 62 provided on the side surfaces of the resin layers 51 to 53.

The thin film capacitors 10A and 10B have mutually the same structure. The thin film capacitor 10A includes a lower electrode 20A, an upper electrode 30A, and a dielectric layer 11A positioned between the lower and upper electrodes 20A and 30A. Similarly, the thin film capacitor 10B includes a lower electrode 20B, an upper electrode 30B, and a dielectric layer 11B positioned between the lower and upper electrodes 20B and 30B. The lower electrode 20A includes an electrode layer 21A made of Ni or the like and contacting the dielectric layer 11A and an electrode layer 22A made of Cu or the like and covering the electrode layer 21A. Similarly, the lower electrode 20B includes an electrode layer 21B made of Ni or the like and contacting the dielectric layer 11B and an electrode layer 22B made of Cu or the like and covering the electrode layer 21B. The upper electrode 30A includes an electrode layer 31A made of Ni or the like and contacting the dielectric layer 11A and an electrode layer 32A made of Cu or the like and covering the electrode layer 31A. Similarly, the upper electrode 30B includes an electrode layer 31B made of Ni or the like and contacting the dielectric layer 11B and an electrode layer 32B made of Cu or the like and covering the electrode layer 31B.

The dielectric films 11A and 11B are each constituted by a perovskite dielectric material, for example. Examples of the perovskite dielectric material include a ferroelectric material or a paraelectric material having a perovskite structure, such as BaTiO₃ (barium titanate), (Ba₁₋ₓSrₓ) TiO₃ (barium strontium titanate), (Ba₁₋ₓCaₓ) TiO₃, PbTiO₃, Pb(ZrₓTi₁₋ₓ)O₃, (Sr₁₋ₓCaₓ), (Ti_{1-y}Zr_{y})O₃, Ba(Mg_{1/3}Ta_{2/3}), a composite perovskite relaxer type ferroelectric material represented by Pb (Mg_{1/3}Nb_{2/3})O₃, and the like, a bismuth layer compound represented by Bi₄Ti₃O₁₂ and SrBi₂Ta₂O₉, a tungsten bronze type ferroelectric material represented by (Sr₁₋ₓBaₓ)Nb₂O₆ and PbNb₂O₆. Here, in the above-described perovskite structure, perovskite relaxer type ferroelectric material, bismuth layer compound, and tungsten bronze type ferroelectric material, the ratio of A site and B site is usually an integer ratio but may be purposely shifted from the integer ratio in order to improve characteristics. In order to control the characteristics of the dielectric films 11A and 11B, the dielectric films 11A and 11B may appropriately contain an additive substance as a subcomponent. The relative permittivity (εᵣ) of each of the dielectric films 11A and 11B is 10 or more, for example. Further, the larger the dielectric withstand voltage of each of the dielectric films 11A and 11B, the better, and there is not particular restriction on the upper limit value thereof. The larger the relative permittivity of each of the dielectric films 11A and 11B, the better, and there is not particular restriction on the upper limit value thereof. The thickness of each of the dielectric films 11A and 11B is about 10 nm to about 6000 nm, for example.

A connection electrode 40A including electrode layers 41A and 42A is provided in the same layer as that of the upper electrode 30A. The connection electrode 40A is connected to the lower electrode 20A through a via hole 12A formed in the dielectric layer 11A. Similarly, a connection electrode 40B including electrode layers 41B and 42B is provided in the same layer as that of the upper electrode 30B. The connection electrode 40B is connected to the lower electrode 20B through a via hole 12B formed in the dielectric layer 11B.

The multilayer thin film capacitor 100 according to the present embodiment has a configuration in which the thin film capacitors 10A and 10B are laminated one on another such that the lower electrode 20A of the thin film capacitor 10A and the lower electrode 20B of the thin film capacitor 10B face each other. The upper electrode 30A of the thin film capacitor 10A and the upper electrode 30B of the thin film capacitor 10B are connected in common to the terminal electrode 61. On the other hand, the connection electrode 40A of the thin film capacitor 10A and the connection electrode 40B of the thin film capacitor 10B are connected in common to the terminal electrode 62. As a result, the two thin film capacitors 10A and 10B are connected in parallel between the terminal electrodes 61 and 62.

The resin layers 51 to 53 are protective members for embedding therein the thin film capacitors 10A and 10B. The resin layer 51 is positioned between the thin film capacitors 10A and 10B, the resin layer 52 covers the upper electrode 30A of the thin film capacitor 10A, and the resin layer 53 covers the upper electrode 30B of the thin film capacitor 10B. The resin layers 51 to 53 respectively have glass cloths 51G to 53G, whereby the stiffness of the multilayer thin film capacitor 100 is significantly enhanced, and the occurrence of warpage thereof is suppressed.

The content ratio of the glass cloths 51G to 53G in the respective resin layers 51 to 53 is preferably 30% or more by volume and 75% or less by volume. When the content ratio of the glass cloths 51G to 53G exceeds 75% by volume, adhesion to the thin film capacitors 10A and 10B may become insufficient; on the other hand, when the content ratio of the glass cloths 51G to 53G is less than 30% by volume, the shape of the multilayer thin film capacitor 100 cannot be maintained due to insufficient stiffness, making it more likely to cause warpage. To ensure sufficient adhesion to the thin film capacitors 10A and 10B and sufficient stiffness of the multilayer thin film capacitor 100, the content ratio of the glass cloths 51G to 53G in the respective resin layers 51 to 53 is more preferably 40% by volume or more and 70% by volume or less. Further, by disposing the glass cloths 51G to 53G at positions as close as possible to the centers of the respective resin layers 51 to 53 in the thickness direction, it is possible to enhance symmetry between the resin layers 51 to 53 in the thickness direction, with the result that the warpage of the multilayer thin film capacitor 100 can be suppressed.

As described above, in the multilayer thin film capacitor 100 according to the present embodiment, the two thin film capacitors 10A and 10B are not simply laminated through the resin layer, but the glass cloth 51G is included in the resin layer 51 positioned between the thin film capacitors 10A and 10B, so that the stiffness of the entire multilayer thin film capacitor 100 can be significantly enhanced. In addition, in the present embodiment, the thin film capacitors 10A and 10B are laminated one on another such that the lower electrode 20A of the thin film capacitor 10A and the lower electrode 20B of the thin film capacitor 10B face each other, so that symmetry in the vertical direction becomes high, thus making it unlikely to cause warpage.

The following describes a manufacturing method for the multilayer thin film capacitor 100 according to the present embodiment.

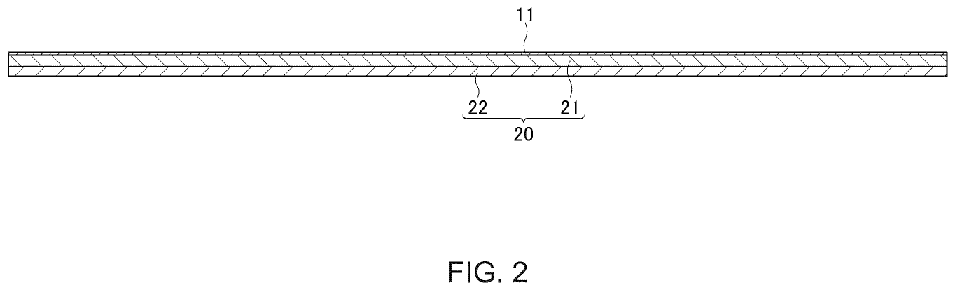

FIGS. 2 to 10 are process views for explaining the manufacturing method for the multilayer thin film capacitor 100 according to the present embodiment.

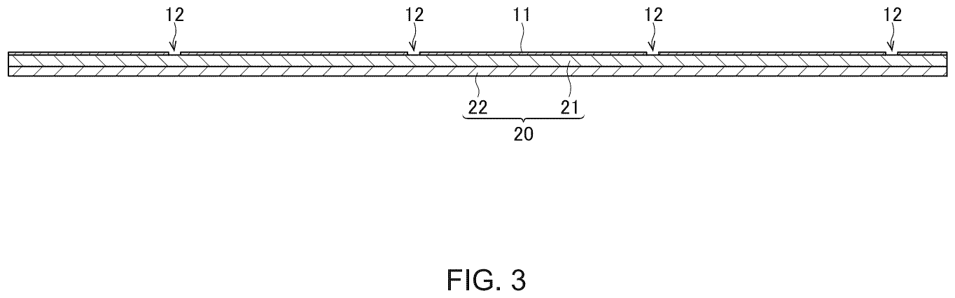

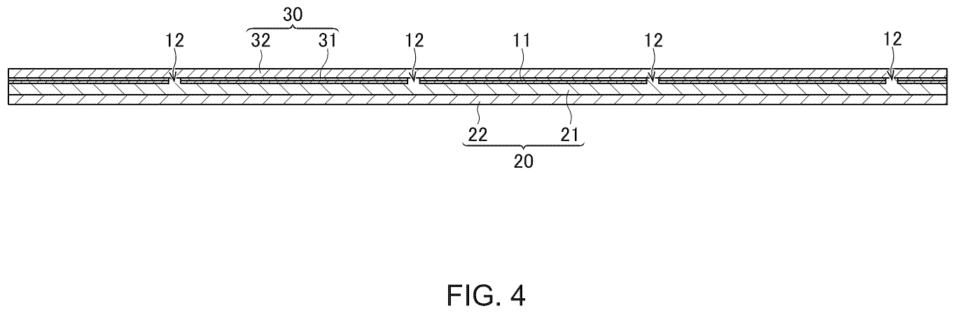

First, the dielectric layer 11 is formed on the surface of the lower electrode 20 (FIG. 2). The lower electrode 20 has a structure in which the electrode layer 21 made of Ni or the like and the electrode layer 22 made of Cu or the like are laminated one on another, and the dielectric layer 11 is formed on the surface of the electrode layer 21. Subsequently, the dielectric layer 11 is patterned to form a plurality of via holes 12 therein (FIG. 3), and then the upper electrode 30 is formed on the surface of the dielectric layer 11 (FIG. 4). The upper electrode 30 has a structure in which the electrode layer 31 made of Ni or the like and the electrode layer 32 made of Cu or the like are laminated one on another, and the electrode layer 31 is formed on the surface of the dielectric layer 11. As a result, the via holes 12 are filled with the electrode layer 31, and the lower electrode 20 and upper electrode 30 are connected to each other through the via holes 12.

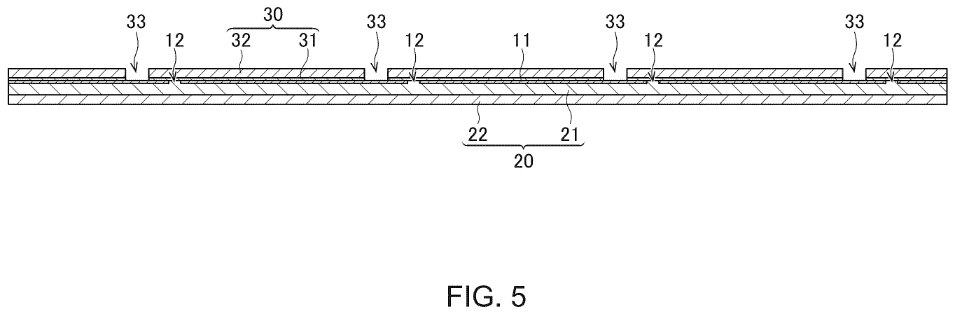

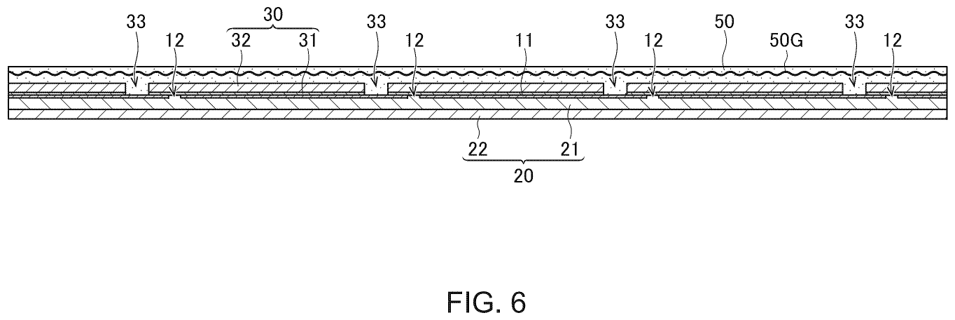

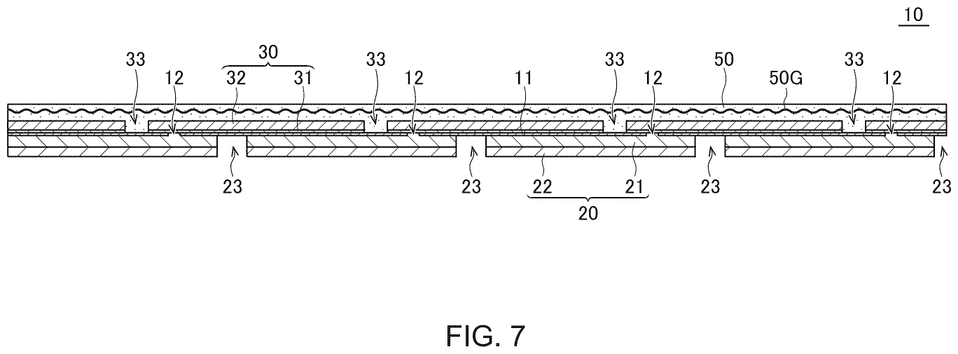

Then, the upper electrode 30 is patterned to form slits 33 (FIG. 5). As a result, the upper electrode 30 is divided into a plurality of parts. Subsequently, the resin layer 50 including the glass cloth 50G is formed so as to cover the patterned upper electrode 30 (FIG. 6). As a result, the slits 33 are filled with the resin layer 50. Subsequently, the lower electrode 20 is patterned to form the slits 23 (FIG. 7). As a result, the lower electrode 20 is divided into a plurality of parts. Through the above processes, a thin film capacitor sheet 10 is completed.

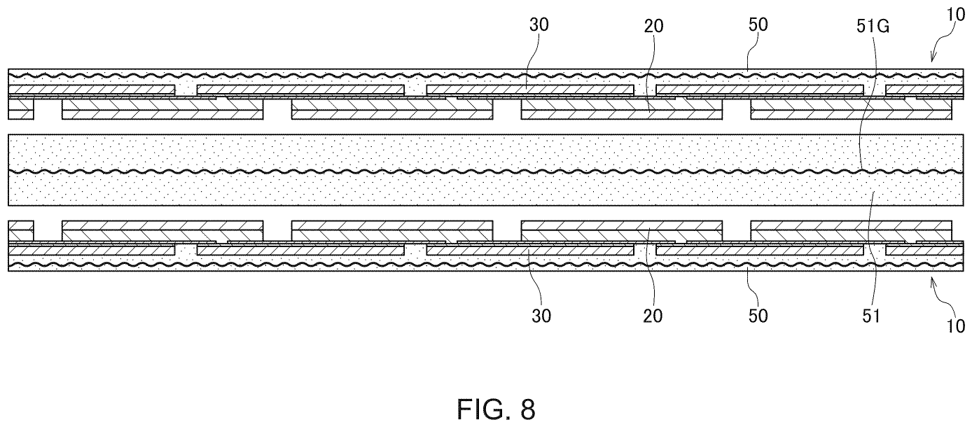

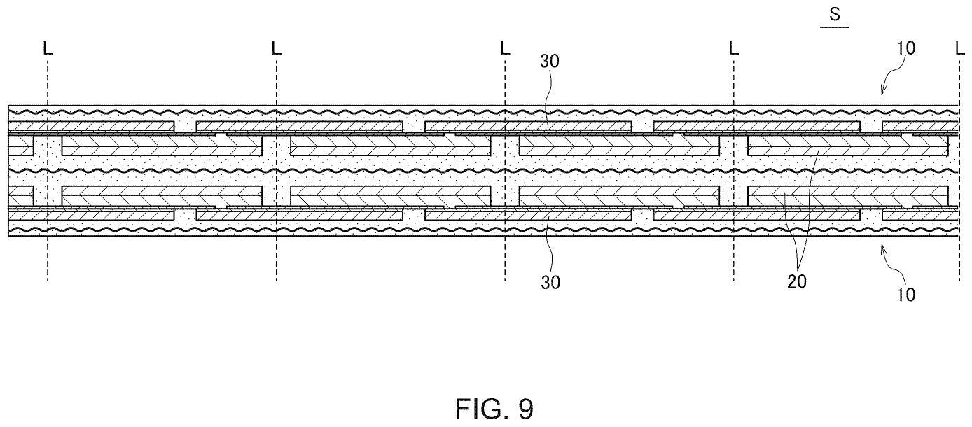

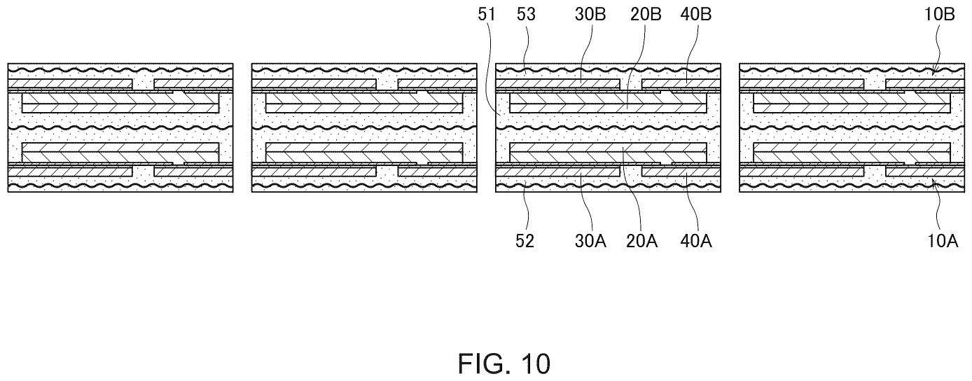

A plurality of the thus configured thin film capacitor sheet 10 are produced, and two thin film capacitor sheets 10 are laminated one on another through the resin layer 51 including the glass cloth 51G (FIG. 8). Specifically, the two thin film capacitor sheet 10 are laminated one on another such that the lower electrodes 20 included in the two respective thin film capacitor sheets 10 face each other. This forms a multilayer thin film capacitor sheet S (FIG. 9). Then, the multilayer thin film capacitor sheet S is divided along the dashed lines L overlapping the respective slits 23 to thereby obtain a plurality of individual multilayer thin film capacitors 100 (FIG. 10).

As a result, the part included in one thin film capacitor sheet 10 becomes the thin film capacitor 10A, and the part included in the other thin film capacitor sheet 10 becomes the thin film capacitor 10B. Further, a part of the resin layer 50 that covers the one thin film capacitor sheet 10 becomes the resin layer 52, and a part of the resin layer 50 that covers the other thin film capacitor sheet 10 becomes the resin layer 53. The upper electrode 30 and connection electrode 40 are separated through the slit 33. Then, the terminal electrodes 61 and 62 are formed on the side surfaces of the resin layers 51 to 53, whereby the multilayer thin film capacitor 100 illustrated in FIG. 1 is completed.

As described above, the two thin film capacitor sheets 10 are laminated one on another through the resin layer 51 including the glass cloth 51G to thereby obtain the multilayer thin film capacitor sheet S, and thereafter, the multilayer thin film capacitor sheet S is divided for singulation, so that it is possible to obtain multiple multilayer thin film capacitors 100.

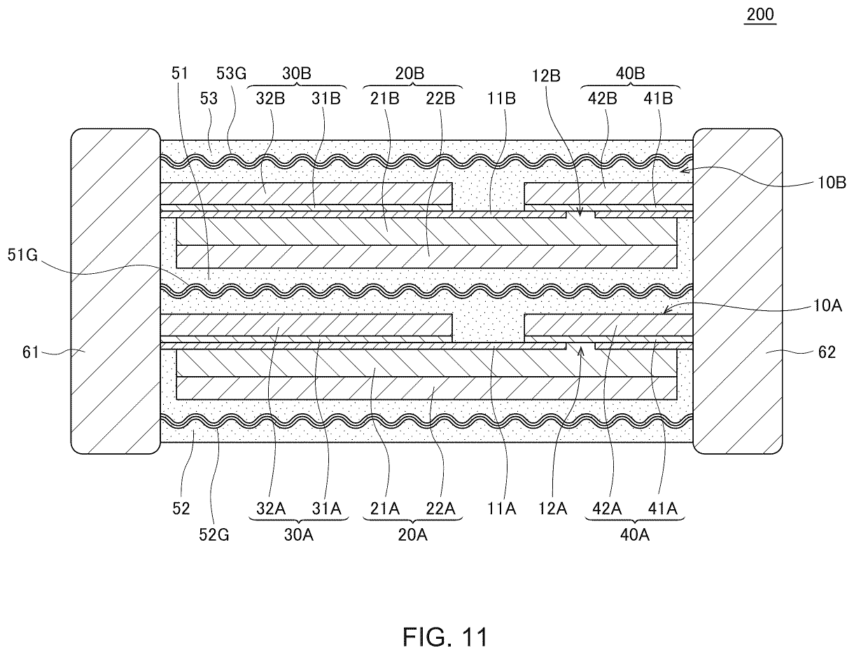

FIG. 11 is a schematic cross-sectional view for explaining the structure of a multilayer thin film capacitor 200 according to a second embodiment of the technology described herein.

As illustrated in FIG. 11, the multilayer thin film capacitor 200 according to the second embodiment differs from the multilayer thin film capacitor 100 according to the first embodiment in that the upper and lower surfaces of the thin film capacitor 10A are reversed. Other basic configurations are the same as those of the multilayer thin film capacitor 100 according to the first embodiment, so the same reference numerals are given to the same elements, and overlapping description will be omitted.

In the multilayer thin film capacitor 200 according to the present embodiment, the thin film capacitors 10A and 10B are laminated one on another such that the upper electrode 30A of the thin film capacitor 10A and the lower electrode 20B of the thin film capacitor 10B face each other. The upper electrode 30A of the thin film capacitor 10A and the lower electrode 20B of the thin film capacitor 10B are connected to different terminal electrodes, so that it is necessary to ensure sufficient insulation therebetween; however, in the multilayer thin film capacitor 200 according to the present embodiment, the glass cloth 51G is interposed between the upper electrode 30A and the lower electrode 20B, thereby ensuring sufficient insulation characteristics. Further, in the present embodiment, the thin film capacitors 10A and 10B are put in the same vertical orientation, and thus, even when three or more thin film capacitors are laminated one on another, the manufacturing process does not become complicated.

While the preferred embodiment Of the present disclosure has been described, the present disclosure is not limited to the above embodiment, and various modifications may be made within the scope of the present disclosure, and all such modifications are included in the present disclosure.

For example, in the above first and second embodiments, the upper electrodes 30A and 30B are connected to the terminal electrode 61, and the lower electrodes 20A and 20B are connected to the terminal electrode 62; however, the connection relation between the thin film capacitors 10A, 10B and the terminal electrodes 61, 62 is not limited to this. Thus, a configuration may be possible in which the upper electrode 30A and lower electrode 20B are connected to the terminal electrode 61, and the upper electrode 30B and lower electrode 20A are connected to the terminal electrode 62.

Further, the multilayer thin film capacitors 100 and 200 according to the first and second embodiments each have a structure in which the two thin film capacitors 10A and 10B are laminated one on another; however, the number of the thin film capacitors to be laminated is not limited to this, and three or more thin film capacitors may be laminated one on another so as to constitute a multilayer thin film capacitor with a larger capacitance.

The technology according to the present disclosure includes the following configuration examples but not limited thereto.

A multilayer thin film capacitor according to an aspect of the present disclosure in which a plurality of thin film capacitors including at least first and second thin film capacitors are laminated, the multilayer thin film capacitor comprising: a first thin film capacitor including a first lower electrode, a first upper electrode, and a first dielectric layer positioned between the first lower electrode and the first upper electrode; a second thin film capacitor including a second lower electrode, a second upper electrode, and a second dielectric layer positioned between the second lower electrode and the second upper electrode; a first resin layer positioned between the first thin film capacitor and the second thin film capacitor and including a glass cloth; a first terminal electrode formed on a first side surface of the first resin layer and connected to the first upper electrode and one of the second upper electrode and the second lower electrode; and a second terminal electrode formed on a second side surface of the first resin layer and connected to the first lower electrode and the other one of the second upper electrode and the second lower electrode. With the above configuration, there can be provided a multilayer thin film capacitor having high stiffness.

The above multilayer thin film capacitor may further include: a second resin layer including a glass cloth, the first thin film capacitor being sandwiched between the first resin layer and the second resin layer; and a third resin layer including a glass cloth, the second thin film capacitor being sandwiched between the first resin layer and the third resin layer. With the above configuration, there can be provided a multilayer thin film capacitor having higher stiffness.

In the above multilayer thin film capacitor, the first terminal electrode may be connected to the first upper electrode and the second upper electrode, and the second terminal electrode may be connected to the first lower electrode and the second lower electrode. This allows the multilayer thin film capacitor to be manufactured without a complicated manufacturing process.

In the above multilayer thin film capacitor, the first thin film capacitor and the second thin film capacitor may be laminated to each other through the first resin layer such that the first upper electrode and the second lower electrode face each other. Even in this case, sufficient insulation can be ensured between the first upper electrode and the second lower electrode due to the presence of the glass cloth.

A method for manufacturing a multilayer thin film capacitor according to an aspect of the present disclosure includes: a first step of forming first and second thin film capacitor sheets by performing a step of forming a dielectric layer and an upper electrode in this order on a lower electrode, a step of patterning the upper electrode to divide the upper electrode into a plurality of parts, and a step of patterning the lower electrode to divide the lower electrode into a plurality of parts; a second step of forming a multilayer thin film capacitor sheet by laminating the first and second thin film capacitor sheets through a first resin layer including a glass cloth; a third step of obtaining a plurality of individual multilayer thin film capacitors by dividing the multilayer thin film capacitor sheet; and a fourth step of forming, on a first side surface of the first resin layer, a first terminal electrode connected to the upper electrode included in the first thin film capacitor sheet and connected to one of the upper electrode and the lower electrode included in the second thin film capacitor sheet and forming, on a second side surface of the first resin layer, a second terminal electrode connected to the lower electrode included in the first thin film capacitor sheet and connected to the other one of the upper electrode and the lower electrode included in the second thin film capacitor sheet. This allows multiple multilayer thin film capacitors with high stiffness to be obtained.

In the above manufacturing method, the first step may further include a step of covering the patterned upper electrode using a second resin layer including a glass cloth, and the second step may be performed by laminating the first and second thin film capacitor sheets such that the lower electrode included in the first thin film capacitor sheet and the lower electrode included in the second thin film capacitor sheet face each other. This allows a multilayer thin film capacitor with high symmetry in the vertical direction to be manufactured.

### REFERENCE SIGNS LIST

10 thin film capacitor sheet
10A, 10B thin film capacitor
11, 11A, 11B dielectric layer
12, 12A, 12B via hole
20, 20A, 20B lower electrode
21, 21A, 21B, 22, 22A, 22B electrode layer
23 slit
30, 30A, 30B upper electrode
31, 31A, 31B, 32, 32A, 32B electrode layer
33 slit
40, 40A, 40B connection electrode
41A, 41B, 42A, 42B electrode layer
50-53 resin layer
50G-53G glass cloth
61, 62 terminal electrode
62 terminal electrode
100, 200 multilayer thin film capacitor
S multilayer thin film capacitor sheet

1. A multilayer thin film capacitor in which a plurality of thin film capacitors including at least first and second thin film capacitors are laminated, the multilayer thin film capacitor comprising:
the first thin film capacitor including a first lower electrode, a first upper electrode, and a first dielectric layer positioned between the first lower electrode and the first upper electrode;
the second thin film capacitor including a second lower electrode, a second upper electrode, and a second dielectric layer positioned between the second lower electrode and the second upper electrode;
a first resin layer positioned between the first thin film capacitor and the second thin film capacitor and including a glass cloth;
a first terminal electrode formed on a first side surface of the first resin layer and connected to the first upper electrode and one of the second upper electrode and the second lower electrode; and
a second terminal electrode formed on a second side surface of the first resin layer and connected to the first lower electrode and other one of the second upper electrode and the second lower electrode.

2. The multilayer thin film capacitor as claimed in claim 1, further comprising:
a second resin layer including a glass cloth, the first thin film capacitor being sandwiched between the first resin layer and the second resin layer; and
a third resin layer including a glass cloth, the second thin film capacitor being sandwiched between the first resin layer and the third resin layer.

3. The multilayer thin film capacitor as claimed in claim 1,
wherein the first terminal electrode is connected to the first upper electrode and the second upper electrode, and
wherein the second terminal electrode is connected to the first lower electrode and the second lower electrode.

4. The multilayer thin film capacitor as claimed in claim 3, wherein the first thin film capacitor and the second thin film capacitor are laminated to each other through the first resin layer such that the first upper electrode and the second lower electrode face each other.

5. A method for manufacturing a multilayer thin film capacitor, the method comprising:
a first step of forming first and second thin film capacitor sheets by performing a step of forming a dielectric layer and an upper electrode in this order on a lower electrode, a step of patterning the upper electrode to divide the upper electrode into a plurality of parts, and a step of patterning the lower electrode to divide the lower electrode into a plurality of parts;
a second step of forming a multilayer thin film capacitor sheet by laminating the first and second thin film capacitor sheets through a first resin layer including a glass cloth;
a third step of obtaining a plurality of individual multilayer thin film capacitors by dividing the multilayer thin film capacitor sheet; and
a fourth step of forming, on a first side surface of the first resin layer, a first terminal electrode connected to the upper electrode included in the first thin film capacitor sheet and connected to one of the upper electrode and the lower electrode included in the second thin film capacitor sheet and forming, on a second side surface of the first resin layer, a second terminal electrode connected to the lower electrode included in the first thin film capacitor sheet and connected to other one of the upper electrode and the lower electrode included in the second thin film capacitor sheet.

6. The method for manufacturing a multilayer thin film capacitor as claimed in claim 5,
wherein the first step further includes a step of covering the patterned upper electrode using a second resin layer including a glass cloth, and
wherein the second step is performed by laminating the first and second thin film capacitor sheets such that the lower electrode included in the first thin film capacitor sheet and the lower electrode included in the second thin film capacitor sheet face each other.
